(19) United States
(12) Patent Application Publication
(10) Pub. No.: US 2014/0248395 A1
(43) Pub. Date: Sep. 4, 2014

(54) CELLULOSE TO PROTEIN BIO-CONVERSION METHOD FOR PRODUCTION OF EDIBLE PROTEIN

(71) Applicant: John C Holliday, Carson City, NV (US)

(72) Inventor: John C. Holliday, Carson City, NV (US)

(73) Assignee: John C Holliday, Carson City, NV (US)

(21) Appl. No.: 14/349,584

(22) PCT Filed: Oct. 8, 2012
(86) PCT No.: PCT/US12/59225

§ 371 Date: Apr. 3, 2014

Related U.S. Application Data
(60) Provisional application No. 61/547,457, filed on Oct. 14, 2011.

(51) Int. Cl. A23K 1/00; C05F 17/02; A23K 1/12

(52) U.S. Cl. CPC A23K 1/007; A23K 1/12; C05F 17/02
USPC 426/53; 426/61; 435/290.1

(57) ABSTRACT

Animal feeds comprising fungal mass and proteinaceous material and methods for bioconverting cellulosic materials to produce the same are described. Also described are apparatuses for use in the methods.

### FIELD OF THE INVENTION

The present invention is directed to a practical method for bioconversion of cellulosic material into protein suitable for use as an animal feed supplement. More particularly, the present invention is directed to a bioconversion method using agricultural waste as a substrate, sterilized and admixed with fungal cultures, which results in fungal growth in the cellulosic substrate and bioconversion of the cellulosic material into high protein fungal tissue, which can be used as a protein supplement for feeding animals.

### BACKGROUND OF THE INVENTION

In the kingdom of fungi, the majority of bioactive compounds are extracellular in nature, that is, they are excreted out of the cells of the fungus into the surrounding environment. Examples of this modus vivendi of fungi can be seen in the way fungi digest their food source, first by excreting digestive compounds that digest the food source in situ, and excreting other compounds which act as transport molecules bringing the nutrients back across the cell walls of the fungal cells. Fungi also excrete compounds to stun or kill bacteria and other organisms to give the fungi an advantage in the food source. The latter compounds are termed “antibiotics” with penicillin serving as the classic example. Other compounds excreted by fungi can be antifungal (against another species) antiviral, antihelminetic or have other biological effects. Thus, the bioactivity of fungi takes place in large measure outside the fungal cell boundary and affects the surrounding environment in subtle or significant ways.

A second characteristic of many species of primary saprophyte fungi, which are defined as those fungi that directly break down cellulose materials, or in other words fungi that grow primarily on trees, is their ability to utilize starch, cellulose, hemicellulose and lignan as the raw materials for their growth. The fungi bioconverts these cellulosic-type materials through complex enzymatic activity, resulting in the production of fungal tissue, which tends to be of a highly proteinaceous nature. When the fungal species is one that produces a tissue edible by the target animal to be fed, and when the fungal species further is one that produces secondary metabolites of a beneficial nature such as antibacterial, antiviral, antihelminetic, immune enhancing or growth stimulating hormones, then the fungal tissue becomes an ideal dietary supplement for humans, both in terms of protein content for primary nutrition and in providing other specific health giving compounds effecting the growth and / or health status of the consumers.

### SUMMARY OF THE INVENTION

The present invention provides a practical method for bioconversion of cellulosic material into protein suitable for use as an animal feed supplement. Conveniently, the bioconversion method can use agricultural waste as a substrate, which can be sterilized and admixed with fungal cultures, to result in fungal growth in the cellulosic substrate and bioconversion of the cellulosic material into high protein fungal tissue.

This biologically converted cellulosic material has great value as a protein source for use in animal feeds. Additionally, the resulting proteinaceous material can be further enhanced by production under specific culture growth conditions to modify the bioconversion in order to create animal feed supplements containing specific factors that act to improve the health and/or cause weight gain of the animals that consume the supplement, above and beyond the value gained from the protein alone. An example of these specific health factors is the production of antibiotic compounds as a result of the use of antibiotic-producing fungi in the bioconversion of the cellulosic substrate.

Thus, in one embodiment, the invention is directed to a method for converting a cellulosic substrate to produce fungal mass and proteinaceous material comprising:
(a) wetting a cellulosic substrate;
(b) sterilizing the wetted substrate to remove microorganisms inhabiting the substrate using a sterilizing agent;
(c) allowing the effect of the sterilizing agent to dissipate;
(d) introducing one or more desired fungal microorganisms to the substrate;
(e) allowing the fungal microorganisms to achieve a desired level of bioconversion of the substrate to produce fungal mass and proteinaceous material; and
(f) collecting the resulting fungal mass and proteinaceous material, wherein the resulting fungal mass and proteinaceous material is suitable as an animal feed.

In certain embodiments, the wetted substrate is sterilized with a sterilizing agent selected from a sterilant gas, hydrogen peroxide, bleach, hydrated lime solution [Ca(OH)2], or a soap solution. In additional embodiments, the sterilant gas is steam.

In further embodiments, the cellulosic substrate is selected from one or more of brewer's grain residue, coffee processing waste, maize stalks, banana leaves, cereal grain straw, cereal, crop residue, roots, stems and leaves, husks, grass, grass hay, sawdust, wood chips, cereal-based industrial processing wastes, paper, cardboard, cellulosic or lignocellulosic material.

In additional embodiments, the one or more fungal microorganisms is one of a Basidiomycetes and/or an Ascomycetes fungus.

In further embodiments, the one or more fungal microorganisms is one or more of Pleurotus ostreatus, Ganoderma lucidum, Volvariella volvacia, Grifola Frondosa, Morchella esculenta, Agaricus bisporus, Cordyceps sinensis or Trametes versicolor.

In yet another embodiment, the invention is directed to a method for producing an animal feed comprising edible fungal mass and proteinaceous material comprising:
(a) wetting a cellulosic substrate;
(b) sterilizing the wetted substrate to remove microorganisms inhabiting the substrate using a sterilizing agent;
(c) allowing the effect of the sterilizing agent to dissipate;
(d) introducing one or more desired fungal microorganisms to the substrate;
(e) allowing the fungal microorganisms to achieve a desired level of bioconversion of the substrate to fungal mass and proteinaceous material; and
(f) collecting the resulting fungal mass and proteinaceous material, to result in a composition suitable for use as an animal feed.

In a further embodiment, the invention is directed to an animal feed comprising fungal mass and proteinaceous material produced by any of the above methods.

In another embodiment, the invention is directed to an apparatus for producing an animal feed as above, the apparatus comprising:
a hard surface configured for placement of a windrow of a cellulosic substrate to be converted to an animal feed comprising fungal mass and proteinaceous material;
a perforated pipe positioned on the hard surface;
a windrow of cellulosic material positioned over the hard surface and perforated pipe; and
a cover positioned over the windrow.

In certain embodiments, the hard surface is a concrete slab. In additional embodiments, the perforated pipe is a perforated steel pipe. In further embodiments, the cover is a sheet-type material, such as a plastic sheet.

In yet additional embodiments, the invention is directed to an enclosed apparatus for producing an animal feed as described above comprising, a surface upon which cellulosic material can be placed, and a pipe or space located beneath the material such that a sterilant gas or liquid, and air for growth of the fungal microorganism, can be introduced.

In certain embodiments, the sterilant gas is steam. In additional embodiments, the apparatus is enclosed within a room.

In further embodiments, the apparatus comprises a shipping container with a perforated false floor or platform upon which the cellulosic material is placed and through which the sterilant gas or liquid, and air is passed.

These and other embodiments of the subject invention will readily occur to those of skill in the art in view of the disclosure herein.

### BRIEF DESCRIPTION OF THE DRAWINGS

FIG. 1 depicts a platform with a perforated pipe upon which a windrow of cellulosic material is placed.

FIG. 2 shows a representative apparatus for use in the bioconversion of cellulosic material into protein suitable for use as an animal feed supplement.

FIG. 3 is a cross section of FIG. 2.

FIG. 4 depicts a platform with several perforated pipes positioned thereon.

FIG. 5 shows an additional representative apparatus for use in the bioconversion of cellulosic material into protein suitable for use as animal feed supplement.

FIG. 6 is a cross section of FIG. 5.

### DETAILED DESCRIPTION OF THE INVENTION

The practice of the present invention will employ, unless otherwise indicated, conventional techniques of plant biology, mycology, microbiology, and the like, which are within the skill of the art. Such techniques are explained fully in the literature.

All publications, patents and patent applications cited herein, whether supra or infra, are hereby incorporated by reference in their entirety.

It must be noted that, as used in this specification and the appended claims, the singular forms “a”, “an” and “the” include plural referents unless the content clearly dictates otherwise. Thus, for example, reference to “a microorganism” includes a mixture of two or more such microorganisms, and the like.

The present invention is based in part on the discovery that cellulosic substrates can be bioconverted using fungal microorganisms to edible animal feeds comprising fungal mass and proteinaceous material. By “cellulosic” substrate is meant a plant substrate which includes cellulose. Cellulose is contained in nearly every natural, free-growing plant, tree, and bush, in meadows, forests, and fields, as well as in cultivated plants and agricultural products. Cellulosic substrates can include substrates derived from lignocellulose-containing materials. Lignocellulose is a structural material that comprises much of the mass of plants. Lignocellulose is composed mainly of cellulose, hemicellulose and lignin. Corn stover, switchgrass, miscanthus, woodchips and the byproducts of lawn and tree maintenance are some of the more abundant cellulosic materials.

The animal feed produced according to the invention can be used to provide a high protein diet to a vertebrate subject, as a dietary supplement, medicinal product, nutraceutical, food additive, and the like.

By “vertebrate subject” is meant any member of the subphylum chordata, including, without limitation, humans and other primates, including non-human primates such as chimpanzees and other apes and monkey species; mammals such as farm animals such as cattle, sheep, pigs, goats and horses; domestic mammals such as dogs and cats; laboratory animals including rodents such as mice, rats and guinea pigs; birds, including domestic, wild and game birds such as chickens, turkeys and other gallinaceous birds, ducks, geese, and the like. The term does not denote a particular age. Thus, both adult and newborn individuals are intended to be covered. The invention described herein is intended for use in any of the above vertebrate species.

In accordance with the present invention advantageous properties of certain fungal species can be used in animal feed which itself may compose, without limitation, fungal biomass grown upon agricultural waste by-products such as, but not limited to brewer's grain residue, coffee processing waste, maize stalks, banana leaves, cereal grain straw, grass or grass hay, sawdust, wood chips or other cellulosic or lignocellulosic material, and cereal based industrial processing wastes. Paper or cardboard can also be used as feed substrates when properly prepared, in combination with the fungal biomass and the intrinsic enzymatic activity which bioconverts the cellulose paper or cardboard raw materials into high quality protein usable as feedstuff for animals.

The fungi used for this bioconversion can be any one of, or a combination of several of the Basidiomycetes and /or ascomycetes fungi usually known as the “edible mushrooms”. Nonlimiting examples of these fungi include fungi from the species Pleurotus, Ganoderma, Volvariella, Grifola, Morchella, Agaricus and Cordyceps, such as Pleurotus ostreatus, Ganoderma lucidum, Ganoderma applanatum, Volvariella volvacia, Grifola Frondosa, Morchella esculenta, Agaricus bisporus, Cordyceps sinensis, Trametes versicolor, or any of a number of other edible mushrooms.

Other filamentous fungi that do not produce edible mushrooms can also be advantageously used in the present process, provided they produce a fungal mass which is edible and non-harmful to the target species of animal to be fed. For example, Rhizopus oligosporus, often used in the food product Tempeh, will find use with the present invention. Moreover, when edible mushroom species are used, the fungus can be used before the mushroom is actually produced or while immature.

Even though known and normally edible mushroom species are preferred for this process, it is important to realize that growth for a long enough period of time to produce the fleshy spore bearing fruitbody (the mushroom) is not necessary nor generally desirable, as nearly complete conversion of the cellulosic material into fungal tissue and fungal byproducts occurs far sooner than the production of mushrooms. From a simply economic perspective, it is desirable to harvest and utilize the proteinaceous fungal biomass as soon as practical, usually within 10 to 20 days after the start of the process.

To conduct such a bioconversion process, it is required to first sterilize or pasteurize the raw material cellulosic substrate to kill any and all, or at least the majority of, the wild microorganisms which initially inhabit or contaminate the raw materials. These microorganisms consist of, among other things, bacteria and wild fungal species which can limit or inhibit the bioconversion process, or produce secondary metabolites of a nature toxic to the target animals to be fed the protein end product, or in other ways compete for the nutrient source and inhibit the speed or the rate of conversion of cellulose to protein. Thus, the raw material substrate is sterilized or pasteurized by applying a suitable sterilizing agent, such as steam or hot water, for a suitable time to ensure partial or full sterilization. Other sterilant agents suitable for raw materials, include but are not limited to, a hydrogen peroxide solution or a bleach solution or a hydrated lime solution or soap solution or a gaseous sterilant such as ethyl or methyl bromide, or ozone, or formaldehyde, or other such gasses as may result in partial or complete sterilization of the material. Alternatively, ultraviolet light or ionizing radiation may be used. Other means whereby partial or complete sterilization of the material may be accomplished are well known in the art.

As explained above, the sterilization/ pasteurization step is used to reduce the number the wild-type organisms present to a level that is below the threshold for the target organism to be grown. Such a level of pasteurization or sterilization will be known or easily determined through trials by one of skill in the art of mushroom cultivation.

After the raw material cellulosic substrate has reached a state of sufficient sterility as determined by the target organisms to be used for the bioconversion and the substrate used, specific target fungal organisms described above are introduced into the raw material in such a manner and at such a rate to act as an inoculant, and take growth in the cellulosic material to the exclusion or near exclusion of other organisms, and which will cause, after a period of growth, a the total or near total bioconversion from the initial cellulose to the desired end product, which is the protein-rich supplement to be used for animal feed.

Such a bioconversion process requires sterile culture techniques be employed for a successful outcome. The major limitations in such a concept of large scale cellulose to protein bioconversion is the difficulty in sterilizing large masses of cellulosic waste and the inability of atmospheric oxygen to penetrate sufficiently into the cellulosic mass to allow thorough fungal growth throughout the mass. Thus, one unique feature of the present invention is a simple and low cost process developed to accomplish this bioconversion of cellulose to protein. One method of bioconverting the cellulosic substrate to protein involves a simple arrangement of perforated piping to introduce steam or other sterilant agent for the initial sterilization of the raw material cellulosic substrate, and to provide the oxygen required for the fungal metabolic processes.

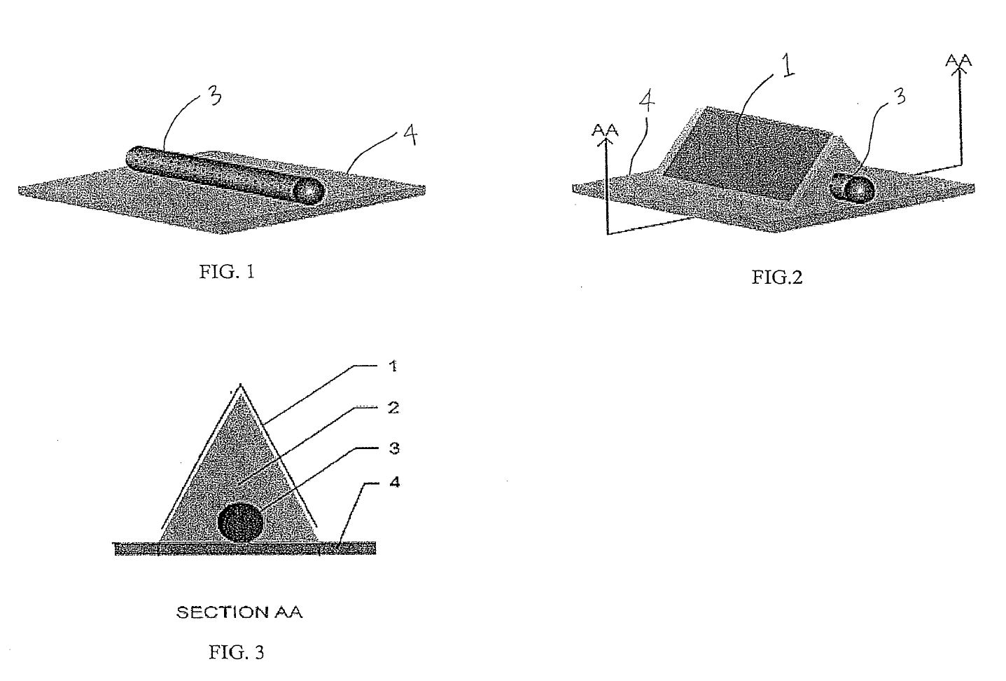

Referring now to FIGS. 1-3, a perforated pipe (3) of sufficient diameter, such as between 1 inch and 4 inches in diameter, preferably between 1.5 and 2 inches in diameter, is laid down upon a suitable surface (4), such as upon the surface of a concrete slab. The pipe can be made of any of several materials, including metal, ceramic, fiberglass, concrete, plastic or wood. Suitable metals include, without limitation, steel, iron, copper or aluminum, such as unfinished, black (lacquer) steel, carbon steel, stainless steel, galvanized steel, brass, and ductile iron. Inconel, chrome moly and titanium steel alloys may also be used.

The raw material cellulosic waste is laid down upon this pipe and piled up thereupon, into the form of a windrow (2). This windrow can be any shape and size as fits the angle of repose of the raw materials, but is preferably in the cross sectional shape of an equilateral triangle, approximately one meter wide at the base and one meter high. This windrow of raw cellulosic agricultural waste material, such as any of the materials described above, for example, straw, is then wetted such as with a hose, until a state of saturation exists. The state of saturation will be dependent on the material used and is well known by those of skill in the art. For straw, a state of saturation is between 50 and 70% moisture by weight. The excess water freely runs off the surface, which is designed with sufficient drainage to allow the drainage of excess water to take place.

After the cellulosic raw material is placed and saturated, a simple cover (1) is positioned over the windrow, separating the raw material from free contact with the surrounding air. Suitable covers include without limitation, sheet-like materials such as a plastic sheet, canvas, cloth, vinyl, cardboard, pre-shaped covers, such as covers made from plywood, sheet metal, or other such sheet-like material.

After the placed and saturated raw material is covered, a sterilant, such as a sterilant gas, for example steam, is introduced into the raw material substrate in sufficient quantity and temperature to fully infiltrate every or near every area of the raw material windrow, and heat it thoroughly through the transfer of heat from the steam to the raw material, for such a period of time as to ensure the raw materials are fully sterilized, or as close to fully sterilized as may be required by the pair of substrate and fungal species chosen for the bioconversion process. Such quantity and temperature are well known by those of skill in the art. For example, for a windrow 100 meters long by 1 meter wide by 1 meter high, filled and covered with plastic as described herein, and composed entirely of wheat straw as the cellulosic material, the straw quantity being approximately 1350 pounds in initial dry weight, and the saturation level of the water being approximately 70%, the quantity of steam required to fully sterilize this mass of straw is approximately 3450 lbs of steam per hour, at atmospheric pressure and at a temperature of 100 degrees C., for a period of four hours. These parameters are sufficient to ensure complete or as nearly complete sterility as can be measured by normal methods throughout all portions of the windrow.

The sterilization may also be conducted by pumping another sterilant gas, such as but not limited to ethylene, or methyl bromide, or formaldehyde gas, or through the process of pumping a liquid sterilant through the aforementioned perforated pipe, such as but not limited to a bleach solution, or a solution of hydrogen peroxide, or any other liquid or gaseous sterilant as may be found suitable for the full sterilization of the raw material windrow. After such sterilization, the raw materials are allowed to cool to ambient temperature, or if a gaseous or liquid sterilant is used, fresh air is passed through the windrow sufficient to fully expel the residual sterilant gas or liquid.

After such cooling or sterilant clearing is performed, the plastic drape, or other windrow cover, is temporarily removed from the surface of the windrow, just long enough to allow the introduction of a fungal inoculum of solid or liquid nature, similar to the process that would be used in traditional inoculation of mushroom substrate. The preparation of a suitable mushroom inoculant or spawn type material, and the rate of its application upon and into the windrow will be well known to one of skill in the art of mushroom cultivation or sterile tissue culture of fungi.

After this inoculation of the windrow is performed, the plastic drape or other cover is replaced upon the windrow to exclude free contact with the outside air. The windrow then becomes a self-contained growth chamber, allowing the fungal species inoculated therein to grow throughout the cellulosic material, bioconverting the raw materials into a protein rich fungal tissue mass. This growth will take place at a rate and for a period of time until the oxygen available for the fungal metabolic process is consumed. This oxygen inflow and carbon dioxide outflow are the primary limiting factors in the amount of cellulose that is bioconvertable to proteinaceous materials, and affect the length of time required to perform a full bioconversion.

At this point the perforated pipe, which was left in place after the initial sterilization, is used to introduce fresh air into the windrow, on such a time schedule and for such a duration as required by the organism for full growth and metabolism as determined by the choice of species, and the exact substrate and the prevailing temperature at which the windrow is maintained. As an example, for the windrow 100 meters long by 1 meter wide by 1 meter high as used in the previous example, when inoculated with the single species of the oyster mushroom Pleurotus ostreatus, it has been found that a continuous flow of 100 cfm of free air is sufficient for optimal growth, or even as low an air flow as a pulsed input of fresh air to the perforated pipe of 20 cfm air for a period of 10 minutes, repeated every hour, so the pile is aerated from underneath through the perforated pipe for a period of 10 minutes of aeration followed by 50 minutes of no aeration, then repeated throughout the bioconversion process. Any airflow between these extremes is suitable, and the airflow can be altered to other quantities depending on the particular growth requirements determined by the species of fungus and the raw material substrate.

Again using the straw windrow as described above, the conversion of cellulose to fungal tissue takes place at a rate of conversion of 1350 lbs of raw material straw converted to proteinaceous matter in a period of 18-20 days under the conditions of moisture and airflow described herein, and at an ambient temperature of 70-80 degrees Fahrenheit.

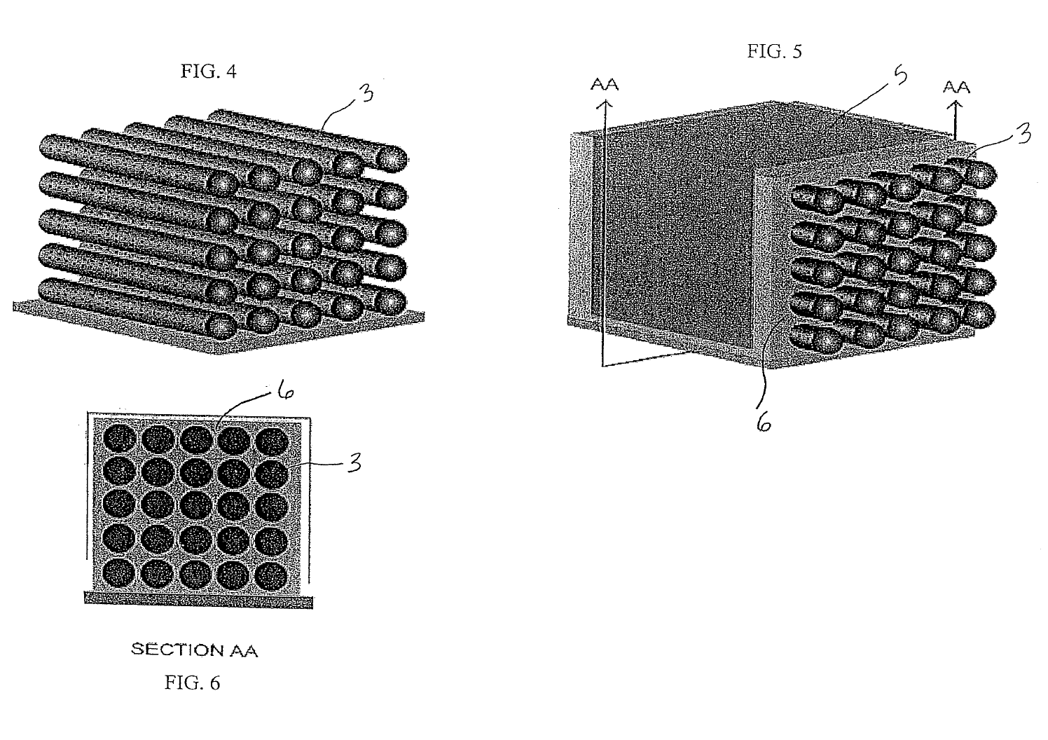

An alternative apparatus for use with the present invention is seen in FIGS. 4-6. As shown therein, a large container (5), such as a shipping container, a room, a large building, e.g., a barn or warehouse or larger, is filled with layers of perforated pipes (3) placed in a mass of cellulosic material (6). The perforated pipes can be placed in a field or container of virtually limitless dimension. The spacing between the perforated pipes can be, for example, approximately 24 inches apart horizontally and 24 inches apart vertically, building layer upon layer of perforated piping while filling cellulosic material in between and around the piping. In this way, the sterilant agent can be successfully applied, and the metabolic oxygen can be successfully provided, while allowing the building of a pipe or the filling of a building of virtually unlimited size, allowing for large scale cellulose to protein bioconversion, using the methods detailed herein.

Thus, methods and apparatuses for producing an animal feed comprising edible fungal mass and proteinaceous material have been disclosed. Although preferred embodiments of the subject invention have been described in some detail, it is understood that obvious variations can be made without departing from the spirit and the scope of the invention as defined by the appended claims.

1. A method for converting a cellulosic substrate to produce fungal mass and proteinaceous material comprising:
(a) wetting a cellulosic substrate;
(b) sterilizing the wetted substrate to remove microorganisms inhabiting the substrate using a sterilizing agent;
(c) allowing the effect of the sterilizing agent to dissipate;
(d) introducing one or more desired fungal microorganisms to the substrate;
(e) allowing the fungal microorganisms to achieve a desired level of bioconversion of the substrate to produce fungal mass and proteinaceous material; and
(f) collecting the resulting fungal mass and proteinaceous material, wherein the resulting fungal mass and proteinaceous material is suitable as an animal feed.

2. The method of claim 1, wherein the wetted substrate is sterilized with a sterilizing agent selected from a sterilant gas, hydrogen peroxide, bleach, hydrated lime solution [Ca(OH)2], or a soap solution.

3. The method of claim 2, wherein the wetted substrate is sterilized using a sterilant gas.

4. The method of claim 3, wherein the sterilant gas is steam.

5. The method of claim 1, wherein the cellulosic substrate is selected from one or more of brewer's grain residue, coffee processing waste, maize stalks, banana leaves, cereal grain straw, cereal, crop residue, roots, stems and leaves, husks, grass, grass hay, sawdust, wood chips, cereal-based industrial processing wastes, paper, cardboard, cellulosic or lignocellulosic material.

6. The method of claim 1, wherein the one or more fungal microorganisms is one of a Basidiomycetes and/or an Ascomycetes fungus.

7. The method of claim 6, wherein the one or more fungal microorganisms is one of more of Pleurotus ostreatus, Ganoderma lucidum, Volvariella volvacia, Grifola Frondosa, Morchella esculenta, Agaricus bisporus, Cordyceps sinensis or Trametes versicolor.

8. A method for producing an animal feed comprising edible fungal mass and proteinaceous material comprising:
(a) wetting a cellulosic substrate;
(b) sterilizing the wetted substrate to remove microorganisms inhabiting the substrate using a sterilizing agent;
(c) allowing the effect of the sterilizing agent to dissipate;
(d) introducing one or more desired fungal microorganisms to the substrate;
(e) allowing the fungal microorganisms to achieve a desired level of bioconversion of the substrate to fungal mass and proteinaceous material; and
(f) collecting the resulting fungal mass and proteinaceous material, to result in a composition suitable for use as an animal feed.

9. An animal feed comprising fungal mass and proteinaceous material produced by the method of claim 8.

10. An apparatus for producing the animal feed of claim 9, said apparatus comprising:
a hard surface configured for placement of a windrow of a cellulosic substrate to be converted to an animal feed which comprises fungal mass and proteinaceous material;
a perforated pipe positioned on the hard surface;
a windrow of cellulosic material positioned over the hard surface and perforated pipe; and
a cover positioned over the windrow.

11. The apparatus of claim 10, wherein the hard surface is a concrete slab.

12. The apparatus of claim 10, wherein the perforated pipe is a perforated steel pipe.

13. The apparatus of claim 10, wherein the cover is a sheet-type material.

14. The apparatus of claim 13, wherein the sheet-type material is a plastic sheet.

15. An enclosed apparatus for producing the animal feed of claim 9 comprising, a surface upon which cellulosic material can be placed, and a pipe or space located beneath the material such that a sterilant gas or liquid, and air for growth of the fungal microorganism, can be introduced.

16. The enclosed apparatus of claim 14, wherein the sterilant gas is steam.

17. The apparatus of claim 15, enclosed within a room.

18. The apparatus of claim 15, wherein the apparatus comprises a shipping container with a perforated false floor or platform upon which the cellulosic material is placed and through which the sterilant gas or liquid, and air is passed.
